(19) United States
(12) Patent Application Publication
(10) Pub. No.: US 2007/0200816 A1
(43) Pub. Date: Aug. 30, 2007

(54) DECODER CIRCUIT HAVING LEVEL SHIFTING FUNCTION AND LIQUID CRYSTAL DRIVE DEVICE USING DECODER CIRCUIT

(75) Inventor: Takashi Taguchi, Minato-ku, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/679,532

(22) Filed: Feb. 27, 2007

(30) Foreign Application Priority Data
Feb. 28, 2006 (JP) 2006-053607

(51) Int. Cl. G09G 3/36

(52) U.S. Cl. 345/100

(57) ABSTRACT

A semiconductor integrated circuit device includes first to k-th decoders, and a MOS transistor switch group having a hierarchical structure of first to k-th hierarchies and operated on a second voltage level. An n-bit input signal of a first voltage level is divided into k groups (k is an integral number equal to or larger than 2) and input to the first to k-th decoders. The first to k-th decoders decode the input signal, shift the decode results to the second voltage level higher than the first voltage level and output the same. The MOS transistor switch group is supplied with 2ⁿ analog inputs at the first hierarchy, selects one of the 2ⁿ analog inputs and outputs the selected analog input from the k-th hierarchy.

### CROSS-REFERENCE TO RELATED APPLICATIONS

This application is based upon and claims the benefit of priority from prior Japanese Patent Application No. 2006-053607, filed Feb. 28, 2006, the entire contents of which are incorporated herein by reference.

### BACKGROUND OF THE INVENTION

1. Field of the Invention

This invention relates to a decoder circuit having a level shifting function and a liquid crystal drive device using the decoder circuit.

2. Description of the Related Art

In a liquid crystal drive device such as a source driver LSI which drives a liquid crystal display device of an active matrix system such as a thin-film transistor (TFT) system, a digital-to-analog conversion process of converting n-bit digital input data into gradation display voltage of 2ⁿ gradations is performed to display gradations in the liquid crystal display device.

In the digital-to-analog conversion circuit, a switch group using MOS transistors as analog switches is used. Generally, as the MOS transistors of the switch group, high-withstand voltage MOS transistors are used. Since digital input data is set at low voltage, a level shifter which converts the level of the digital input data from low voltage to high voltage is provided in the preceding stage of the digital-to-analog conversion circuit in the general source driver LSI (for example, refer to Jpn. Pat. Appln. KOKAI Publication No. 2002-196726).

Further, it is proposed to realize the digital-to-analog conversion circuit by use of a decoder circuit (for example, refer to Jpn. Pat. Appln. KOKAI Publication No. H06-303141). In the decoder circuit, switch groups of MOS transistors are arranged in a matrix form and the on/off states of the MOS transistors are controlled according to digital input data. Thus, the combination of the on/off states of the MOS transistors is switched according to digital input data and desired gradation display voltage is selected.

That is, in the conventional source driver LSI, n-bit digital input data is level-shifted by a level shifter and then input to a decoder circuit configured by the switch groups of MOS transistors arranged in the matrix form and an output selected by the decoder circuit is supplied to the liquid crystal display device as 2ⁿ gradation voltage.

However, in order to cope with the tendency of the recent liquid crystal display device to have multiple bits and multiple outputs, an extremely large number of transistors are required in the source driver LSI using the above level shifter and decoder circuit. For example, when input data is n-bit data, (n×2ⁿ) MOS transistors are required for each output only in the switch group of MOS transistors configuring the decoder circuit. Therefore, there may occur a problem that the chip size of the source driver LSI is increased and the manufacturing yield is lowered accordingly.

### BRIEF SUMMARY OF THE INVENTION

According to one aspect of this invention, there is provided a semiconductor integrated circuit including first to k-th decoders (k is an integral number not smaller than 2) to which an n-bit input signal of a first voltage level divided into k groups is input and which decode the input signal, shift decode results to a second voltage level higher than the first voltage level and output the same, and a MOS transistor switch group having a hierarchical structure of first to k-th hierarchies corresponding to the first to k-th decoders and controlled based on the decode results output from the first to k-th decoders corresponding to the first to k-th hierarchies, the MOS transistor switch group being configured to be operated on the second voltage level and supplied with 2ⁿ analog inputs at the first hierarchy, select one of the 2ⁿ analog inputs and output the selected analog input from the k-th hierarchy.

Further, according to another aspect of this invention, there is provided a liquid crystal drive device including a reference voltage generation circuit which generates gradation display reference voltages of 2ⁿ gradations, first to k-th decoders (k is an integral number not smaller than 2) to which n-bit image data of a first voltage level divided into k groups is input and which decode the image data, shift decode results to a second voltage level higher than the first voltage level and output the same, a MOS transistor switch group having a hierarchical structure of first to k-th hierarchies corresponding to the first to k-th decoders and controlled based on the decode results output from the first to k-th decoders corresponding to the first to k-th hierarchies, the MOS transistor switch group being configured to be operated on the second voltage level and supplied with 2ⁿ gradation display reference voltages generated by the reference voltage generation circuit at the first hierarchy, select one of the 2ⁿ gradation display reference voltages and output the selected gradation display reference voltage from the k-th hierarchy, and a liquid crystal display which is supplied with the gradation display voltages and whose gradation is controlled according to the gradation display voltages.

### BRIEF DESCRIPTION OF THE SEVERAL VIEWS OF THE DRAWING

FIG. 1 is a block diagram schematically showing an example of the configuration of a decoder circuit according to a first embodiment of this invention and a liquid crystal drive device using the decoder circuit,

FIG. 2 is a circuit diagram showing an example in which each of switch groups of the decoder circuit shown in FIG. 1 is configured by PMOS transistors,

FIG. 3 is a circuit diagram showing an example of the configuration of each of level-shifting decoders which controls the PMOS transistor switch group shown in FIG. 2,

FIG. 4 is a waveform diagram showing an example of the operation of the level-shifting decoder shown in FIG. 3,

FIG. 5 is a diagram showing a truth table of the level-shifting decoder shown in FIG. 3,

FIG. 6 is a circuit diagram showing an example in which each of switch groups of the decoder circuit shown in FIG. 1 is configured by NMOS transistors,

FIG. 7 is a circuit diagram showing an example of the configuration of each of level-shifting decoders which controls the NMOS transistor switch group shown in FIG. 6,

FIG. 8 is a waveform diagram showing an example of the operation of the level-shifting decoder shown in FIG. 7,

FIG. 9 is a diagram showing a truth table of the level-shifting decoder shown in FIG. 7,

FIG. 10 is a block diagram schematically showing an example of the configuration of a decoder circuit according to a second embodiment of this invention and a liquid crystal drive device using the decoder circuit,

FIG. 11 is a circuit diagram showing an example in which each of switch groups of the decoder circuit shown in FIG. 10 is configured by PMOS transistors,

FIG. 12 is a circuit diagram showing an example of the configuration of each of level-shifting decoders which controls the PMOS transistor switch group shown in FIG. 11, and

FIG. 13 is a diagram showing a truth table of the level-shifting decoder shown in FIG. 12.

### DETAILED DESCRIPTION OF THE INVENTION

### First Embodiment

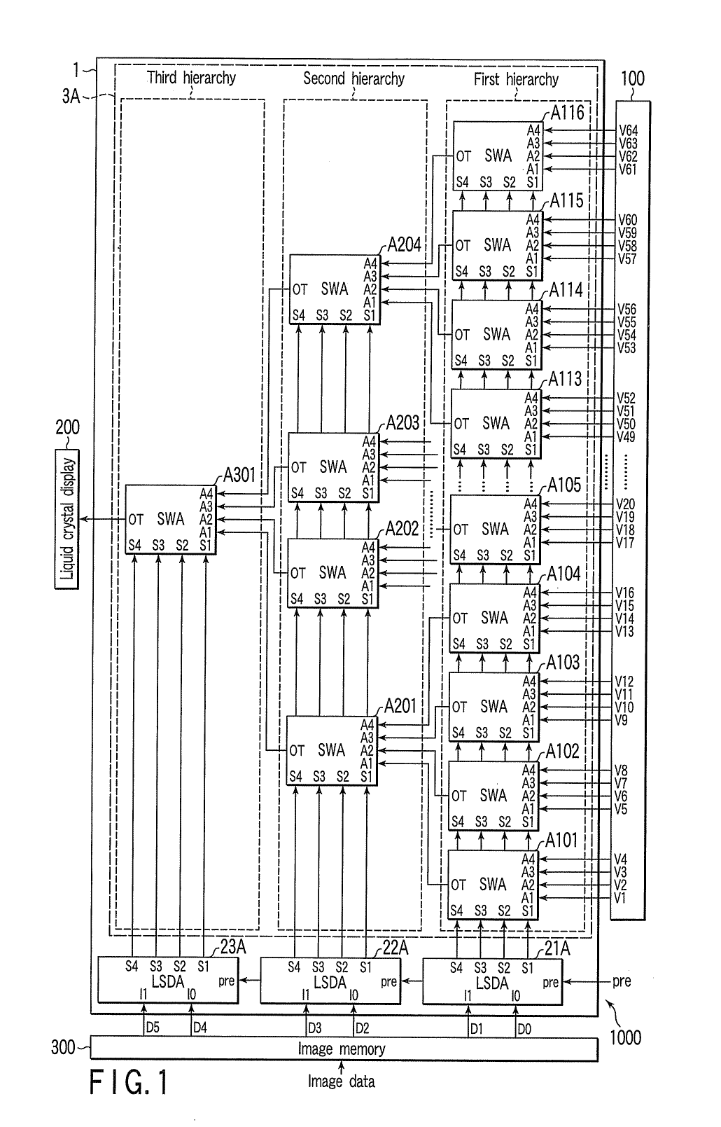

FIG. 1 is a block diagram schematically showing an example of the configuration of a decoder circuit according to a first embodiment of this invention and a liquid crystal drive device using the decoder circuit.

A liquid crystal drive device 1000 of the first embodiment is a source driver LSI which supplies reference voltage selected by a decoder circuit 1 to an active matrix liquid crystal display device (liquid crystal display) 200 as gradation display voltage. The decoder circuit 1 is supplied with image data fetched into an image memory 300 as 6-bit input signals D0 to D5. The decoder circuit 1 decodes the 6-bit input signals D0 to D5 and selects one of reference voltages V1 to V64 of 64 steps for 2⁶ (=64) gradation display generated from a reference voltage generation circuit 100. The voltage selected by the decoder circuit 1 is supplied to the liquid crystal display 200 as gradation display voltage.

The decoder circuit 1 of the first embodiment includes three level-shifting decoders (LSDA) 21A to 23A and a MOS transistor switch group 3A whose switching operation is controlled by output signals of the level-shifting decoders 21A to 23A. The MOS transistor switch group 3A is formed of high-withstand voltage MOS transistors and has a hierarchical structure of three hierarchies (k=3).

The level-shifting decoders 21A to 23A are supplied with 6-bit (n=6) input signals D0 to D5 which are divided into three (k=3) bit groups (the number of bits allocated to each bit group can be selectively set, but two bits are allocated to each of the three groups in this example) from the image memory 300. The signal levels of the input signals D0 to D5 are set at a low-voltage level of 3.3V, for example. Each of the level-shifting decoders 21A to 23A decodes 2-bit input signals I0, I1 of a corresponding bit group and outputs four decoded output signals S1 to S4. The signal levels of the decoded output signals S1 to S4 are set at a high-voltage level of 10V, for example. The decoded output signals S1 to S4 are respectively supplied to MOS transistor switch groups of the hierarchies (first hierarchy to third hierarchy) corresponding to the level-shifting decoders 21A to 23A of the MOS transistor switch group 3A.

The first hierarchical MOS transistor switch group is configured by 64 MOS transistors which select 16 voltages from 64 reference voltages V1 to V64 input from the reference voltage generation circuit 100. The second hierarchical MOS transistor switch group is configured by 16 MOS transistors which select four voltages from 16 output voltages of the first hierarchical MOS transistor switch group. The third hierarchical MOS transistor switch group is configured by four MOS transistors which select one voltage from four output voltages of the second hierarchical MOS transistor switch group. The output voltage of the third hierarchical MOS transistor switch group is used as gradation display voltage supplied to the liquid crystal display 200.

The above MOS transistor switch group of each hierarchy is configured by using a 4-transistor switch group (SWA) formed of four MOS transistors as one unit. The 64-MOS transistor switch group of the first hierarchy is configured by 4-transistor switch groups A101 to A116. The 16-MOS transistor switch group of the second hierarchy is configured by 4-transistor switch groups A201 to A204. The 4-MOS transistor switch group of the third hierarchy is configured by a 4-transistor switch group A301.

The switching operations of the MOS transistor switch groups of the respective hierarchies are controlled by the decoded output signals S1 to S4 of the respective level-shifting decoders 21A, 22A and 23A. That is, the 4-transistor switch groups A101 to A116 of the first hierarchy are commonly controlled by the decoded output signals S1 to S4 of the level-shifting decoder 21A. The 4-transistor switch groups A201 to A204 of the second hierarchy are commonly controlled by the decoded output signals S1 to S4 of the level-shifting decoder 22A. The 4-transistor switch group A301 of the third hierarchy is controlled by the decoded output signals S1 to S4 of the level-shifting decoder 23A.

As described above, in the decoder circuit according to the first embodiment, first, input signals D0 to D5 input from the image memory 300 to the decoder circuit 1 are divided into three bit groups and supplied to the level-shifting decoders 21A to 23A and the input signals D0 to D5 of the respective bit groups are level-shifted and decoded. Then, the switching operation of the MOS transistor switch group 3A is controlled by the output signals S1 to S4 of the level-shifting decoders 21A to 23A and one of the 64 reference voltages V1 to V64 input from the reference voltage generation circuit 100 is selected and supplied to the liquid crystal display 200 as gradation display voltage. At this time, 16 voltages among 16 groups each including four voltages are selected from the reference voltages V1 to V64 at the first hierarchy, four voltages are selected from four groups each including four voltages at the second hierarchy and one voltage is selected from four groups at the third hierarchy.

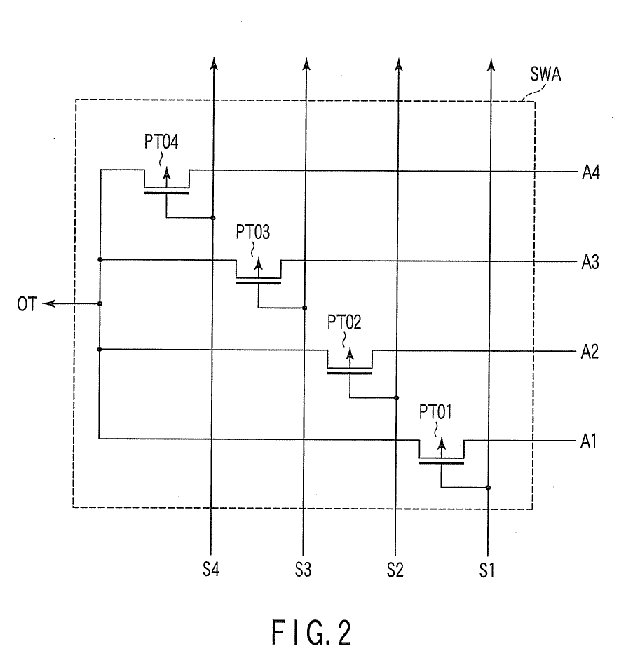

FIG. 2 is a circuit diagram showing an example in which the 4-transistor switch group (SWA) in the circuit shown in FIG. 1 is configured by high-withstand voltage PMOS transistors.

The source electrodes of PMOS transistors PT01, PT02, PT03, PT04 are connected to input terminals A1, A2, A3, A4 and the drain electrodes thereof are commonly connected to an output terminal OT. Further, the decoded output signals S1, S2, S3, S4 of each of the level-shifting decoders 21A t 23A are supplied to the gate electrodes of the PMOS transistors PT01, PT02, PT03, PT04.

The signals S1, S2, S3, S4 are controlled and only one of them is set to low level. Thus, only one of the PMOS transistors PT01, PT02, PT03, PT04 is turned on and input voltage applied to one of the input terminals of the input terminals A1, A2, A3, A4 which is connected to the source electrode of the PMOS transistor set in the on state is output to the output terminal OT.

That is, one of the input voltages input to the input terminals A1, A2, A3, A4 is selected according to the signals S1, S2, S3, S4 and output to the output terminal OT.

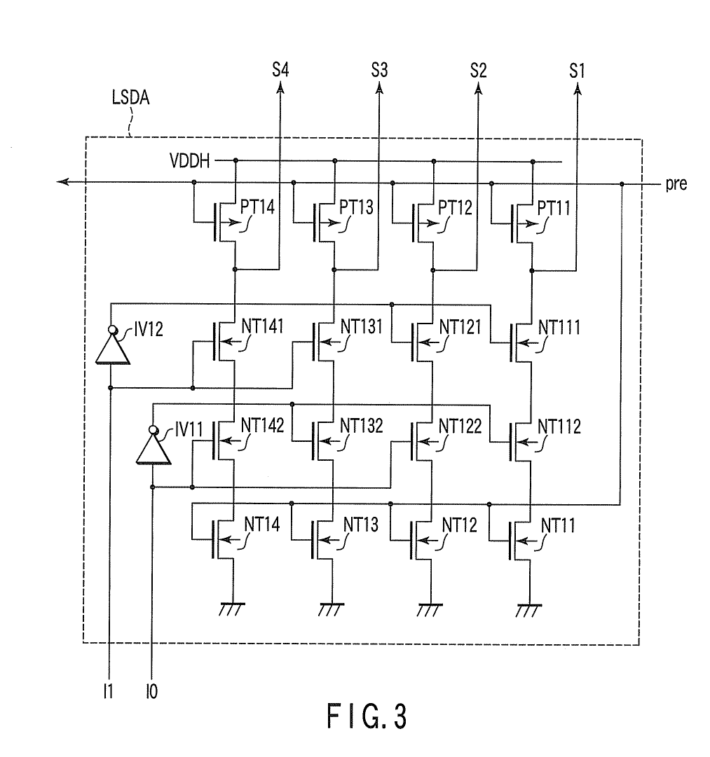

FIG. 3 is a circuit diagram showing an example of the configuration of the level-shifting decoder (LSDA) in the circuit shown in FIG. 1. The level-shifting decoder generates and supplies signals S1, S2, S3, S4 which control the 4-transistor switch group SWA configured by the PMOS transistors shown in FIG. 2.

The source electrodes of high-withstand voltage PMOS transistors PT11, PT12, PT13, PT14 are connected to a high-withstand voltage power supply terminal VDDH and the signals S1, S2, S3, S4 are output from the respective drain electrodes thereof. A precharge signal pre is commonly input to the gate electrodes of the PMOS transistors PT11, PT12, PT13, PT14.

The current paths of high-withstand voltage NMOS transistors NT111, NT112 and NMOS transistor NT11 are serially connected between the drain electrode of the PMOS transistor PT11 and a ground terminal. The current paths of high-withstand voltage NMOS transistors NT121, NT122 and NMOS transistor NT12 are serially connected between the drain electrode of the PMOS transistor PT12 and the ground terminal. The current paths of high-withstand voltage NMOS transistors NT131, NT132 and NMOS transistor NT13 are serially connected between the drain electrode of the PMOS transistor PT13 and the ground terminal. The current paths of high-withstand voltage NMOS transistors NT141, NT142 and NMOS transistor NT14 are serially connected between the drain electrode of the PMOS transistor PT14 and the ground terminal.

A precharge signal pre is commonly input to the gate electrodes of the NMOS transistors NT11, NT12, NT13, NT14. Further, an input signal I0 is input to the gate electrodes of the NMOS transistors NT122, NT142 and an input signal I1 is input to the gate electrodes of the NMOS transistors NT131, NT141. Also, a signal obtained by inverting the input signal I0 by an inverter IV11 is input to the gate electrodes of the NMOS transistors NT112, NT132 and a signal obtained by inverting the input signal I1 by an inverter IV12 is input to the gate electrodes of the NMOS transistors NT111, NT121.

In this case, the signal levels of the input signals I0, I1 are set at the low-voltage level and the inverters IV11, IV12 are inverters operated on low voltage. Therefore, the signal levels of outputs of the inverters IV11, IV12 are also set at the low-voltage level. When the threshold voltage Vth is set at 1V, for example, it is possible to identify and drive the high-withstand voltage NMOS transistor even if the input voltage level is set at the low-voltage level, for example, the binary 0 level is set at 0V and the binary 1 level is set at 3.3V.

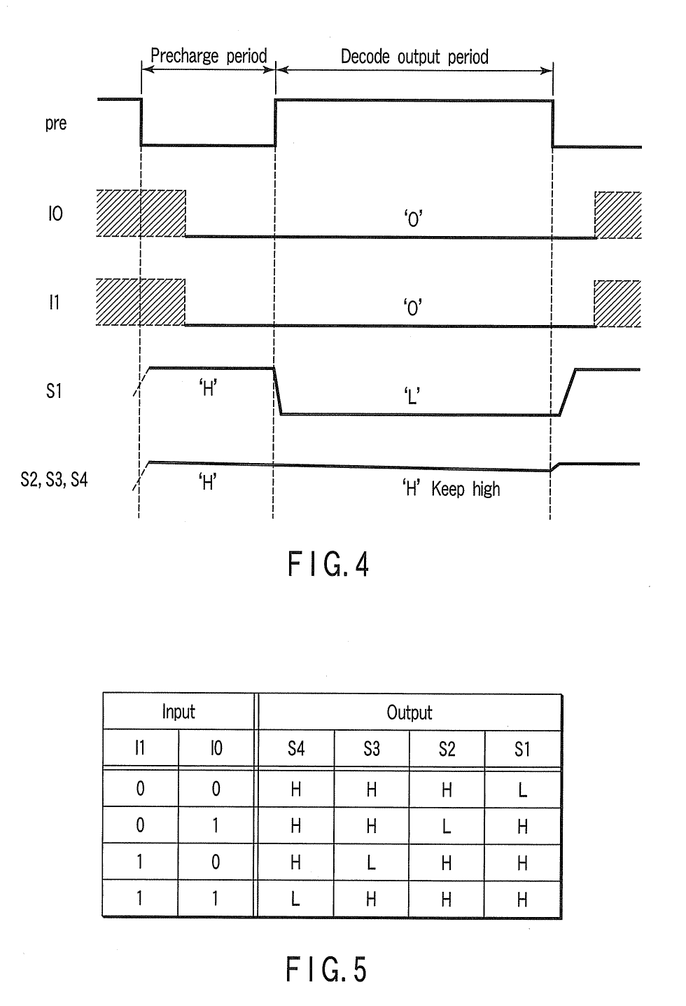

FIG. 4 is a waveform diagram showing an example of the operation of the level-shifting decoder LSDA shown in FIG. 3.

A precharge period is set when the precharge signal pre is binary 0 and, at this time, all of the PMOS transistors PT11, PT12, PT13, PT14 are turned on and all of the NMOS transistors NT11, NT12, NT13, NT14 are turned off. As a result, the signal levels of all of the output signals S1, S2, S3, S4 are high indicating the high-voltage level.

When the precharge signal pre is binary 1, all of the PMOS transistors PT11, PT12, PT13, PT14 are turned off and all of the NMOS transistors NT11, NT12, NT13, NT14 are turned on. Thus, a decode output period in which the decode results of the input signals I0, I1 are output is set. In this period, since all of the PMOS transistors PT11, PT12, PT13, PT14 are off, only the output signal of the terminal of those of the NMOS transistors serially connected to the source terminals of the NMOS transistors NT11, NT12, NT13, NT14 in the on state which are both turned on is made low. Each of the other output terminals is set in the high-impedance state and keeps the output high in the precharge period since the PMOS transistor and at least one of the NMOS transistors whose current paths are serially connected thereto are turned off.

In the waveform diagram of FIG. 4, an example in which the input signals I0, I1 are both binary 0 in the decode output period is shown.

In the decode output period, since the input signals I0, I1 are both binary 0, only the output signal S1 of the terminal of the NMOS transistors NT111, NT112 whose current paths are serially connected to the source terminal of the NMOS transistor NT11 and which are both on is made low. Each of the other output signals S2, S3, S4 is kept high since at least one of the NMOS transistors serially connected to the output terminal is turned off.

FIG. 5 is a diagram showing a truth table indicating the relation between the input signal and output signal during the decode output period of the level-shifting decoder (LSDA) shown in FIG. 3.

As shown in FIG. 5, one of the output signals S1, S2, S3, S4 which is made low is output according to a combination of the signal levels of the input signals I0, I1. Then, one of the PMOS transistors in the 4-transistor switch group SWA can be turned on by controlling the 4-transistor switch group SWA configured by the PMOS transistors shown in FIG. 2 by use of the output signals S1, S2, S3, S4 in the decode output period.

An example in which the 4-transistor switch group SWA is configured by the PMOS transistors is explained above, but the 4-transistor switch group SWA can be configured by use of high-withstand voltage NMOS transistors.

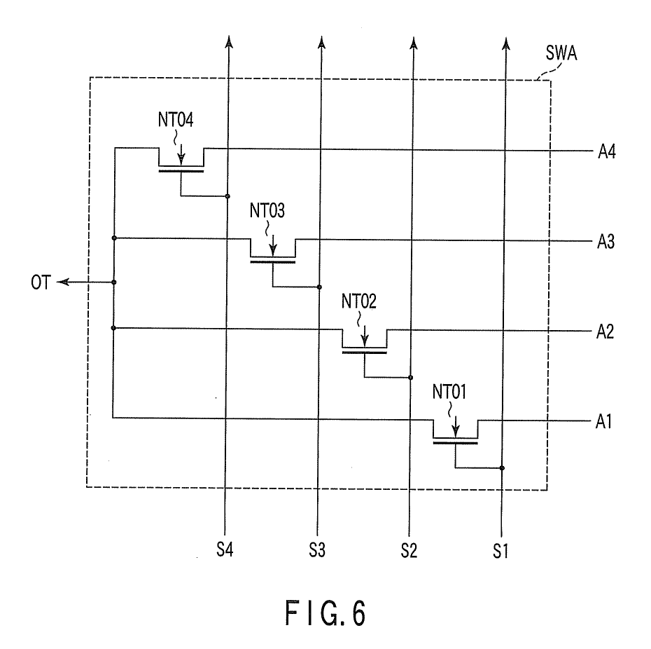

FIG. 6 is a circuit diagram showing an example in which the 4-transistor switch group SWA is configured by high-withstand voltage NMOS transistors. The circuit configuration itself is attained by replacing the PMOS transistors PT01, PT02, PT03, PT04 of the 4-transistor switch group SWA configured by the PMOS transistors shown in FIG. 2 by NMOS transistors NT01, NT02, NT03, NT04.

In this case, since the NMOS transistor is turned on when the a signal supplied to the gate electrode thereof is high, the polarities of the signals S1, S2, S3, S4 must be inverted with respect to those set when the 4-transistor switch group SWA is configured by the PMOS transistors. That is, a high signal is supplied only to the gate electrode of one of the NMOS transistors NT01, NT02, NT03, NT04 which is desired to be turned on.

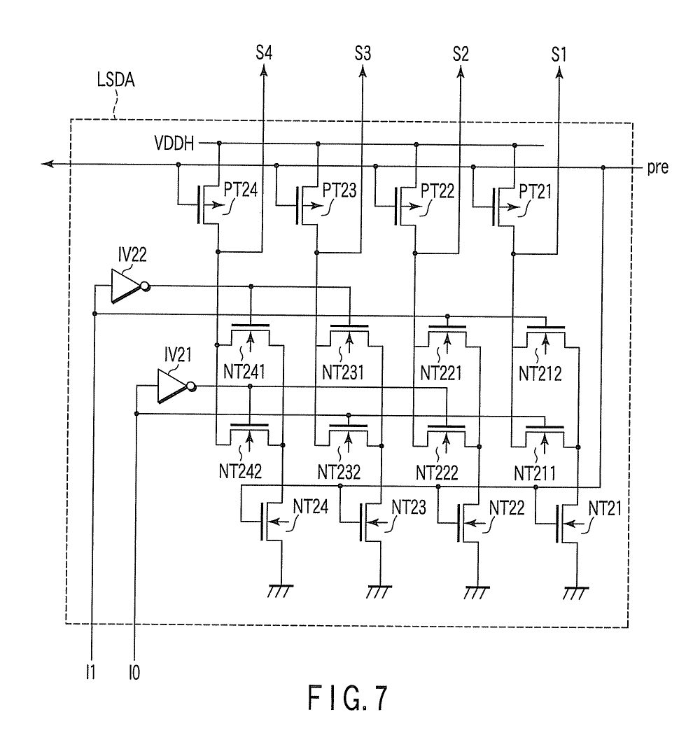

FIG. 7 is a circuit diagram showing an example of the configuration of the level-shifting decoder LSDA which outputs the signals S1, S2, S3, S4 to control the 4-transistor switch group SWA configured by the NMOS transistors shown in FIG. 6.

The level-shifting decoder LSDA shown in FIG. 7 is different from the level-shifting decoder (LSDA) shown in FIG. 3 in that the current paths of NMOS transistors NT211 and NT212 are connected in parallel between the drain terminal of the PMOS transistor PT21 and the drain terminal of the NMOS transistor NT21, the current paths of NMOS transistors NT221 and NT222 are connected in parallel between the drain terminal of the PMOS transistor PT22 and the drain terminal of the NMOS transistor NT22, the current paths of NMOS transistors NT231 and NT232 are connected in parallel between the drain terminal of the PMOS transistor PT23 and the drain terminal of the NMOS transistor NT23, and the current paths of the NMOS transistors NT241 and NT242 are connected in parallel between the drain terminal of the PMOS transistor PT24 and the drain terminal of the NMOS transistor NT24.

Like the inverters IV21, IV22 shown in FIG. 2, inverters IV21, IV22 are operated on low voltage and output inverted signals of the input signals I0, I1.

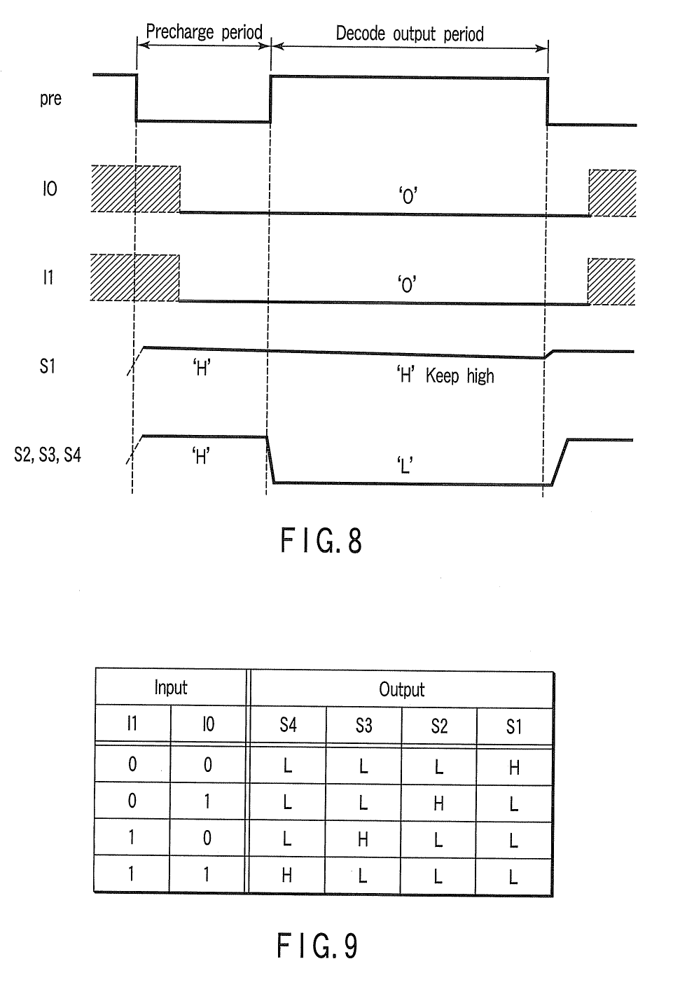

FIG. 8 is a waveform diagram showing an example of the operation of the level-shifting decoder (LSDA) shown in FIG. 7.

Also, in this case, the precharge period is set when the precharge signal pre is binary 0, all of the PMOS transistors PT21, PT22, PT23, PT24 are turned on and all of the NMOS transistors NT21, NT22, NT23, NT24 are turned off. As a result, the signal levels of all of the output signals S1, S2, S3, S4 are made high, indicating the high-voltage level.

When the precharge signal pre is binary 1, all of the PMOS transistors PT21, PT22, PT23, PT24 are turned off and all of the NMOS transistors NT21, NT22, NT23, NT24 are turned on. Thus, a decode output period in which the decode results of the input signals I0, I1 are output is set.

However, in this case, in opposition to the case of FIG. 4, since both of the NMOS transistors NT211 and NT212 whose current paths are connected in parallel with the source electrode of the NMOS transistor NT21 are turned off when both of the input signals I0, I1 are binary 0, only the output signal S1 is kept high and the other output signals S2 to S4 are made low.

FIG. 9 is a diagram showing a truth table indicating the relation between the input signal and output signal during the decode output period shown in FIG. 7 of the level-shifting decoder (LSDA).

As shown in FIG. 9, one of the output signals S1, S2, S3, S4 which is high is output according to a combination of the signal levels of the input signals I0, I1. One of the NMOS transistors in the 4-transistor switch group SWA can be turned on by controlling the 4-transistor switch group SWA configured by the NMOS transistors shown in FIG. 6 by use of the output signals S1, S2, S3, S4 in the decode output period.

Thus, according to the first embodiment, it is not necessary to insert a level shifter since the level-shifting decoder outputs the decoded output of the input signal of the low-voltage level at the high-voltage level, and the circuit configuration can be simplified accordingly.

Further, since the input signal is divided into three bit groups and decoded, the MOS transistor switch group can be formed with the hierarchical structure of three hierarchies and the number of MOS transistor switches can be significantly reduced in comparison with that in the conventional matrix-form arrangement. For example, in the case of a 6-bit input signal, the number of MOS transistors of the MOS transistor switch group is set to 384 (=6×2⁶) for each output in the conventional matrix-form arrangement, but the number of MOS transistors is set to 84 (=64+16+4) in this embodiment.

Further, since the MOS transistor switch group is formed with three hierarchies, the number of series-connection stages of the current paths of the MOS transistors in the decoder circuit can be reduced from six stages in the conventional case to three stages and the output delay with respect to the input from the reference voltage generation circuit 100 can be improved.

### Second Embodiment

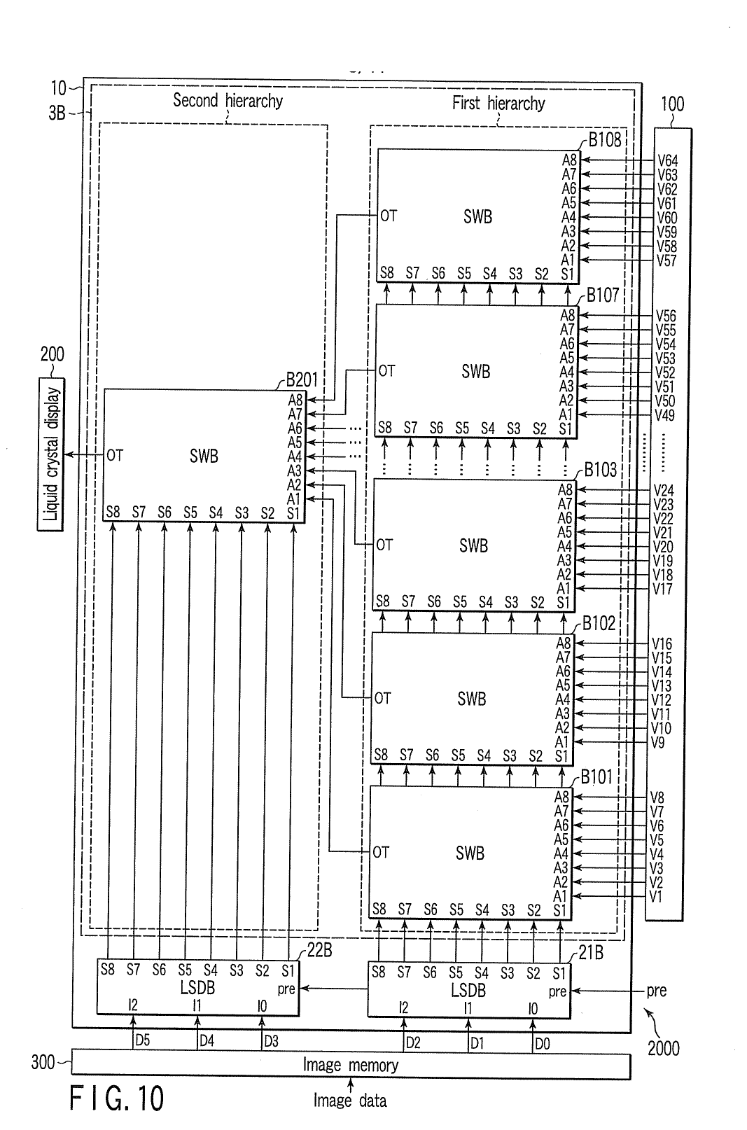

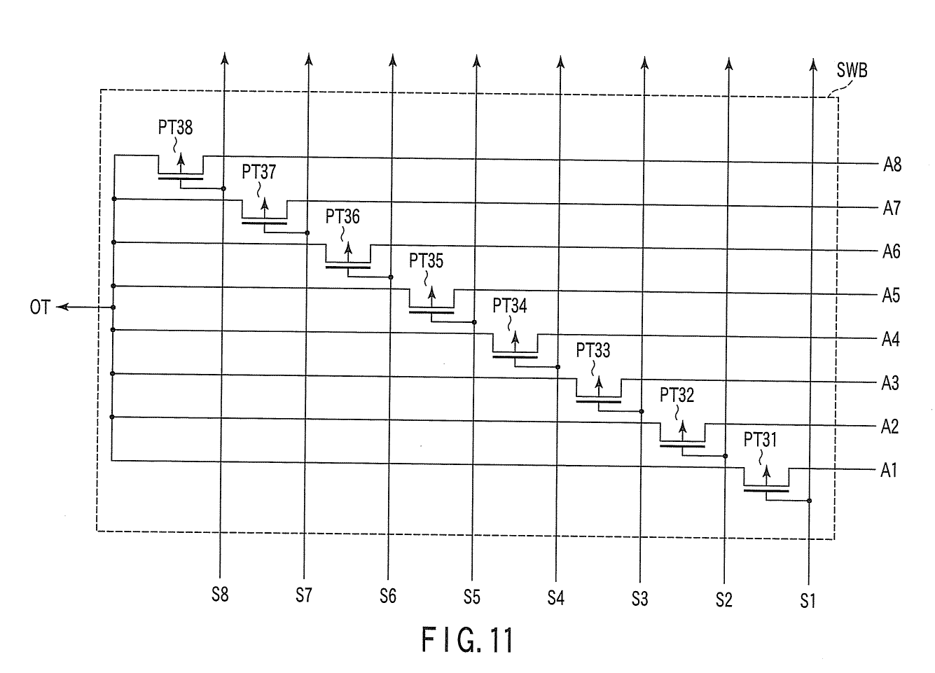

FIG. 10 is a block diagram schematically showing an example of the configuration of a decoder circuit according to a second embodiment of this invention and a liquid crystal drive device using the decoder circuit.

A decoder circuit 10 of the second embodiment includes two level-shifting decoders (LSDB) 21B, 22B and a MOS transistor switch group 3B whose switching operation is controlled by output signals of the level-shifting decoders 21B, 22B. The MOS transistor switch group 3B is formed of high-withstand voltage MOS transistors and has a hierarchical structure of two (k=2) hierarchies.

The level-shifting decoders 21B, 22B are supplied with 6-bit input signals D0 to D5 which are divided into two (k=2) bit groups (the number of bits allocated to each bit group can be selectively set, but two groups of three bits are formed in this example) from an image memory 300. The signal levels of the input signals D0 to D5 are set at a low-voltage level of 3.3V, for example. Each of the level-shifting decoders 21B, 22B decodes a 3-bit input signal (I0, I1, I2) of a corresponding bit group and outputs eight decoded output signals (S1 to S8). The signal levels of the decoded output signals S1 to S8 are set at a high-voltage level of 10V, for example. The decoded output signals S1 to S8 are respectively supplied to MOS transistor switch groups of the hierarchies (first hierarchy and second hierarchy) corresponding to the level-shifting decoders 21B, 22B of the MOS transistor switch group 3B.

The first hierarchical MOS transistor switch group is configured by 64 MOS transistors which select eight voltages from 64 reference voltages V1 to V64 input from the reference voltage generation circuit 100. The second hierarchical MOS transistor switch group is configured by eight MOS transistors which select one voltage from eight output voltages of the first hierarchical MOS transistor switch group. The output signal of the second hierarchical MOS transistor switch group is used as gradation display voltage supplied to the liquid crystal display 200.

The above MOS transistor switch group of each hierarchy is configured by using an 8-transistor switch group (SWB) formed of eight MOS transistors as one unit. The first hierarchical 64-MOS transistor switch group is configured by 8-transistor switch groups B101 to B108. The second hierarchical MOS transistor switch group is configured by an 8-transistor switch group B201.

Like the liquid crystal drive device 1000 of the first embodiment, the liquid crystal drive device 2000 of the second embodiment is a source driver LSI which supplies one reference voltage selected by a decoder circuit 10 from 64-step reference voltages V1 to V64 for 2⁶ (=64) gradation display generated from a reference voltage generation circuit 100 to a liquid crystal display 200 as gradation display voltage.

FIG. 11 is a circuit diagram showing an example in which the 8-transistor switch group SWB is configured by high-withstand voltage PMOS transistors.

The source electrodes of PMOS transistors PT31, PT32, PT33, PT34, PT35, PT36, PT37, PT38 are connected to input terminals A1, A2, A3, A4, A5, A6, A7, A8 and the drain electrodes thereof are commonly connected to an output terminal OT. Further, input signals S1, S2, S3, S4, S5, S6, S7, S8 are respectively supplied to the gate electrodes of the PMOS transistors PT31, PT32, PT33, PT34, PT35, PT36, PT37, PT38.

The input signals S1, S2, S3, S4, S5, S6, S7, S8 are controlled and only one of them is made low. Thus, only one of the PMOS transistors PT31 to PT38 is turned on and input voltage applied to one of the input terminals A1 to A8 which is connected to the source electrode of the PMOS transistor in the on state is output to the output terminal OT.

That is, one of the input voltages input to the input terminals A1 to A8 is selected according to the signals S1 to S8 and output to the output terminal OT.

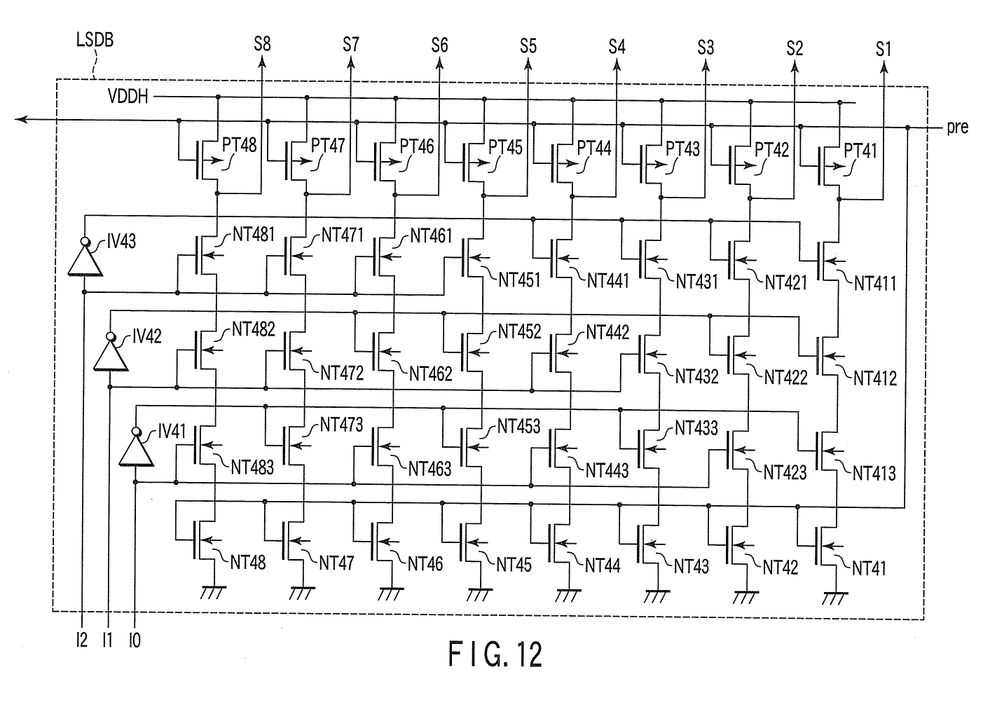

FIG. 12 is a circuit diagram showing an example of the configuration of the level-shifting decoder (LSDB) which outputs the signals S1, S2, S3, S4, S5, S6, S7, S8 to control the 8-transistor switch group SWB configured by the PMOS transistors shown in FIG. 11.

The source electrodes of high-withstand voltage PMOS transistors PT41 to PT48 are connected to a high-voltage power supply terminal VDDH and the signals S1 to S8 are output from the drain electrodes thereof. A precharge signal pre is commonly input to the gate electrodes of the PMOS transistors PT41 to PT48.

The current paths of high-withstand voltage NMOS transistors NT411, NT412, NT413 and NMOS transistor NT41 are serially connected between the drain electrode of the PMOS transistor PT41 and the ground node. The current paths of high-withstand voltage NMOS transistors NT421, NT422, NT423 and NMOS transistor NT42 are serially connected between the drain electrode of the PMOS transistor PT42 and the ground node. The current paths of high-withstand voltage NMOS transistors NT431, NT432, NT433 and NMOS transistor NT43 are serially connected between the drain electrode of the PMOS transistor PT43 and the ground node. The current paths of high-withstand voltage NMOS transistors NT441, NT442, NT443 and NMOS transistor NT44 are serially connected between the drain electrode of the PMOS transistor PT44 and the ground node.

Likewise, the current paths of high-withstand voltage NMOS transistors NT451, NT452, NT453 and NMOS transistor NT45 are serially connected between the drain electrode of the PMOS transistor PT45 and the ground node. The current paths of high-withstand voltage NMOS transistors NT461, NT462, NT463 and NMOS transistor NT46 are serially connected between the drain electrode of the PMOS transistor PT46 and the ground node. The current paths of high-withstand voltage NMOS transistors NT471, NT472, NT473 and NMOS transistor NT47 are serially connected between the drain electrode of the PMOS transistor PT47 and the ground node. The current paths of high-withstand voltage NMOS transistors NT481, NT482, NT483 and NMOS transistor NT48 are serially connected between the drain electrode of the PMOS transistor PT48 and the ground node.

A precharge signal pre is commonly input to the gate electrodes of the NMOS transistors NT41 to NT48. Further, an input signal I0 is input to the gate electrodes of the NMOS transistors NT423, NT443, NT463, NT483, an input signal I1 is input to the gate electrodes of the NMOS transistors NT432, NT442, NT472, NT482 and an input signal I2 is input to the gate electrodes of the NMOS transistors NT451, NT461, NT471, NT481. Further, a signal obtained by inverting the input signal I0 by use of an inverter IV41 is input to the gate electrodes of the NMOS transistors NT413, NT433, NT453, NT473, a signal obtained by inverting the input signal I1 by use of an inverter IV42 is input to the gate electrodes of the NMOS transistors NT412, NT422, NT452, NT462 and a signal obtained by inverting the input signal I2 by use of an inverter IV43 is input to the gate electrodes of the NMOS transistors NT411, NT421, NT431, NT441.

In this case, the signal levels of the input signals I0, I1, I2 are set at the low-voltage level and the inverters IV41, IV42, IV43 are inverters operated on low voltage. Therefore, the signal levels of the outputs of the inverters IV41, IV42, IV43 are set at the low-voltage level. When the threshold voltage Vth is set at 1V, for example, it is possible to identify and drive the high-withstand voltage NMOS transistor even if the input voltage level is set at the low-voltage level, for example, the binary 0 level is set at 0V and the binary 1 level is set at 3.3V.

Like the level-shifting decoder (LSDA) shown in FIG. 3, in the level-shifting decoder (LSDB), a precharge period is set when the precharge signal pre is binary 0 and a decode output period is set when the precharge signal pre is binary 1.

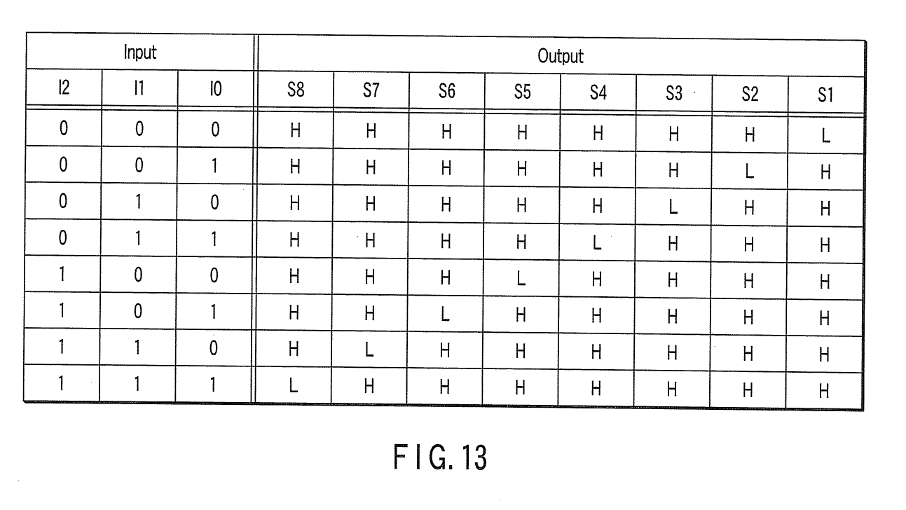

FIG. 13 is a diagram showing a truth table indicating the relation between the input signal and output signal in the decode output period of the level-shifting decoder (LSDB) shown in FIG. 12.

As shown in FIG. 13, one of the output signals S1 to S8 is made low and output according to a combination of the signal levels of the input signals I0, I1, I2. One of the PMOS transistors in the 8-transistor switch group (SWB) can be turned on by controlling the 8-transistor switch group (SWB) configured by the PMOS transistors as shown in FIG. 11 according to the output signals S1 to S8 in the decode output period.

Like the first embodiment, it is, of course, possible to configure the 8-transistor switch group (SWB) by use of NMOS transistors.

According to the second embodiment, the MOS transistor switch group can be divided into two hierarchies by dividing the bit group of the input signals into two. As a result, the number of transistors of the MOS transistor group becomes 72 (=64+8) and can thus be further reduced in comparison with the case of the first embodiment.

In addition, the number of successive connection stages of the MOS transistors in the decoder circuit can be further reduced from three stages in the first embodiment to two stages by dividing the hierarchies of the MOS transistor switch group into two hierarchies. Further, the output delay with respect to the input from the reference voltage generation circuit can be further improved.

Therefore, according to one aspect of this invention, since the decoder circuit having the signal level conversion function can be configured by use of a less number of transistors, an increase in the chip size of the source driver LSI which is the liquid crystal drive device using the decoder circuit can be prevented and a lowering in the manufacturing yield can be prevented

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor integrated circuit comprising:
first to k-th decoders (k is an integral number not smaller than 2) to which an n-bit input signal of a first voltage level divided into k groups is input and which decode the input signal, shift decode results to a second voltage level higher than the first voltage level and output the same, and
a MOS transistor switch group having a hierarchical structure of first to k-th hierarchies corresponding to the first to k-th decoders and controlled based on the decode results output from the first to k-th decoders corresponding to the first to k-th hierarchies, the MOS transistor switch group being configured to be operated on the second voltage level and supplied with 2ⁿ analog inputs at the first hierarchy, select one of the 2ⁿ analog inputs and output the selected analog input from the k-th hierarchy.

2. The semiconductor integrated circuit according to claim 1, wherein each of the first to k-th decoders includes first MOS transistors of a first conductivity type whose current paths are respectively connected between a power supply of the second voltage level and decode output terminals and which are controlled by a precharge signal, second MOS transistors of a second conductivity type whose current paths are grounded at one-side ends and which are controlled by the precharge signal, and third MOS transistors of the second conductivity type whose current paths are respectively connected between the decode output terminals and the other ends of the current paths of the second MOS transistors and which are controlled by the respective bit groups of the input signal, and each of the decode output terminals outputs the second voltage level via the corresponding first MOS transistor in a precharge period set by the precharge signal and outputs a level determined by the corresponding third MOS transistor after the end of the precharge period.

3. The semiconductor integrated circuit according to claim 2, wherein each of the third MOS transistors includes MOS transistors having current paths serially connected between the corresponding decode output terminal and the other end of the current path of the second MOS transistor.

4. The semiconductor integrated circuit according to claim 3, wherein the MOS transistor switch group includes fourth MOS transistors of the first conductivity type having current paths connected at one-side ends to input terminals and commonly connected at the other ends to the output terminal and gate electrodes respectively connected to the decode output terminals to be supplied with output signals of the decoders.

5. The semiconductor integrated circuit according to claim 4, wherein the first conductivity type is a P-channel type, the second conductivity type is an N-channel type and only one of the decode output terminals which corresponds to the MOS transistors of the third MOS transistor which are all on outputs a ground level after the end of the precharge period and turns on one of the fourth MOS transistors in the MOS transistor switch group whose gate is connected to the decode output terminal set at ground level.

6. The semiconductor integrated circuit according to claim 2, wherein each of the third MOS transistors includes MOS transistors having current paths connected in parallel between the corresponding decode output terminal and the other end of the current path of the second MOS transistor.

7. The semiconductor integrated circuit according to claim 6, wherein the MOS transistor switch group includes fourth MOS transistors of the second conductivity type having current paths connected at one-side ends to input terminals and commonly connected at the other ends to the output terminal and gate electrodes respectively connected to the decode output terminals to be supplied with output signals of the decoders.

8. The semiconductor integrated circuit according to claim 7, wherein the first conductivity type is a P-channel type, the second conductivity type is an N-channel type and only one of the decode output terminals which corresponds to the MOS transistors of the third MOS transistor which are all off holds an output of a second voltage level after the end of the precharge period and turns on one of the fourth MOS transistors in the MOS transistor switch group whose gate is connected to the decode output terminal set at the second voltage level.

9. The semiconductor integrated circuit according to claim 1, wherein the n-bit input signal is image data.

10. The semiconductor integrated circuit according to claim 1, wherein the 2ⁿ analog inputs are reference voltages for gradation display.

11. The semiconductor integrated circuit according to claim 1, wherein a selected one of the 2ⁿ analog inputs output from the k-th hierarchy of the MOS transistor switch group is supplied to a liquid crystal display as gradation display voltage.

12. A liquid crystal drive device comprising:
a reference voltage generation circuit which generates gradation display reference voltages of 2ⁿ gradations,
first to k-th decoders (k is an integral number not smaller than 2) to which n-bit image data of a first voltage level divided into k groups is input and which decode the image data, shift decode results to a second voltage level higher than the first voltage level and output the same,
a MOS transistor switch group having a hierarchical structure of first to k-th hierarchies corresponding to the first to k-th decoders and controlled based on the decode results output from the first to k-th decoders corresponding to the first to k-th hierarchies, the MOS transistor switch group being configured to be operated on the second voltage level and supplied with 2ⁿ gradation display reference voltages generated by the reference voltage generation circuit at the first hierarchy, select one of the 2ⁿ gradation display reference voltages and output the selected gradation display reference voltage from the k-th hierarchy, and
a liquid crystal display which is supplied with the gradation display voltages and whose gradation is controlled according to the gradation display voltages.

13. The liquid crystal drive device according to claim 12, further comprising an image memory which stores image data, image data stored in the image memory being read out, divided into k groups and input to the first to k-th decoders.

14. The liquid crystal drive device according to claim 12, wherein each of the first to k-th decoders includes first MOS transistors of a first conductivity type whose current paths are respectively connected between a power supply of the second voltage level and decode output terminals and which are controlled by a precharge signal, second MOS transistors of a second conductivity type whose current paths are grounded at one-side ends and which are controlled by the precharge signal, and third MOS transistors of the second conductivity type whose current paths are respectively connected between the decode output terminals and the other ends of the current paths of the second MOS transistors and which are controlled by the respective bit groups of the input signal, and each of the decode output terminals outputs the second voltage level via the corresponding first MOS transistor in a precharge period set by the precharge signal and outputs a level determined by the corresponding third MOS transistor after the end of the precharge period.

15. The liquid crystal drive device according to claim 14, wherein each of the third MOS transistors includes MOS transistors having current paths serially connected between the corresponding decode output terminal and the other end of the current path of the corresponding second MOS transistors.

16. The liquid crystal drive device according to claim 15, wherein the MOS transistor switch group includes fourth MOS transistors of the first conductivity type having current paths respectively connected at one-side ends to input terminals and commonly connected at the other ends to the output terminal and gate electrodes respectively connected to the decode output terminals to be supplied with output signals of the decoders.

17. The liquid crystal drive device according to claim 16, wherein the first conductivity type is a P-channel type, the second conductivity type is an N-channel type and only one of the decode output terminals which corresponds to the MOS transistors of the third MOS transistor which are all on outputs a ground level after the end of the precharge period and turns on one of the fourth MOS transistors in the MOS transistor switch group whose gate is connected to the decode output terminal set at the ground level.

18. The liquid crystal drive device according to claim 14, wherein each of the third MOS transistors includes MOS transistors having current paths connected in parallel between the corresponding decode output terminal and the other end of the current path of the corresponding second MOS transistors.

19. The liquid crystal drive device according to claim 18, wherein the MOS transistor switch group includes fourth MOS transistors of the second conductivity type having current paths respectively connected at one-side ends to input terminals and commonly connected at the other ends to the output terminal and gate electrodes connected to the respective decode output terminals to be supplied with output signals of the decoders.

20. The liquid crystal drive device according to claim 19, wherein the first conductivity type is a P-channel type, the second conductivity type is an N-channel type and only one of the decode output terminals which corresponds to the MOS transistors of the third MOS transistor which are all off holds an output of a second voltage level after the end of the precharge period and turns on one of the fourth MOS transistors in the MOS transistor switch group whose gate is connected to the decode output terminal set at the second voltage level.
